(19) United States
(12) Patent Application Publication
(10) Pub. No.: US 2007/0060295 A1
(43) Pub. Date: Mar. 15, 2007

(54) System and method of a gaming machine with pacing and feedback

(76) Inventors: Lawrence E. DeMar, Winnetka, IL (US); Bradley Berman, Minnetonka, MN (US); Scott D. Slomiany, Rolling Meadows, IL (US); Mark W. Molitor, Chicago, IL (US)

Correspondence Address: Michael H. Baniak;BANIAK PINE & GANNON, Suite 1200, 150 N. Wacker Drive, Chicago, IL, 60606, US

(21) Appl. No.: 11/517,817

(22) Filed: Sep. 8, 2006

Related U.S. Application Data
(60) Provisional application No. 60/715,796, filed on Sep. 9, 2005.

(51) Int. Cl. A63F 13/00

(52) U.S. Cl. 463/20

(57) ABSTRACT

The present invention enhances a player's experience during gameplay. Anticipation and suspense are accomplished by modifying the pace of the game and/or generating feedback to the player. Anticipation combinations achieved during gameplay trigger the gaming machine to modify the pace of the game and/or generate feedback to the player.

This application claims the benefit of U.S. Provisional Application No. 60/715,796 filed Sep. 9, 2005.

### FIELD OF THE INVENTION

This invention relates to games in general, and particularly to games of chance for pure amusement as well as for live games and gaming machines in a wagering environment, such as in a casino or Internet setting.

### BACKGROUND OF THE INVENTION

Games of chance can include games in which there are no player decisions, and the result is essentially entirely random. For example, a game of chance can include a standard three-reel spinning slot machine. The player makes a wager, but provides no other input. The results of the game are shown to the player in the form of indicia on the reels, and the player receives an award in the case of a winning result. This type of game can be found, for example, in machines that spin mechanical reels or that simulate the reels on a video display, which have been adapted for casino or other gambling environments, as well as on a home computer or game console.

Gaming machines allow a player to place a wager on a game of chance. The gaming machine typically has various categories of preferred results where the player wins more than the value of the wager. Most gaming machines have very favorable results, sometimes called “jackpots”, that occur less frequently than wins of a smaller scale. These jackpots offer a multiple of the player's wager, sometimes a very high multiple such as 100 or 1000 times the initial wager.

In most gaming machines preferable results take the form of a combination of symbols such as 3 Sevens (7-7-7) on a reel spinning slot machine or a Royal Flush on a video poker game (e.g. A h, K h, Q h, J h, 10 h).

It is desirable for the player to feel anticipation as a potentially winning combination develops, whether or not the entire combination is completed. There are games that use backlights or “smart sounds,” which reinforce important combinations as they appear. In this case, a sound is played as each symbol that is part of an important combination is shown. Sometimes, in addition to the sound, a light behind the symbol is illuminated. For example, playing a sound or illuminating the symbol each time it lands on the payline.

There are games that delay the final reel from stopping by allowing one or more extra revolutions of the reel. This adds to the suspense and anticipation of the game when the desired symbol on the final reel could lead to a winning combination.

In five-card draw video poker, play is stopped after each hand is initially dealt in order for the player to decide whether to hold and/or draw each of the cards. This allows for a long anticipation of a big win in the event that a majority of the cards for a winning poker combination are present in the initially dealt hand.

There have been slot machines such as IGT's “Wheel of Fortune” where the game is stopped once the player has earned a bonus round. In this case, the machine waits for the player to press a button to commence play of the bonus round, which was earned by the symbol combination on the reels.

Therefore, there is a demand for games that enhance the player experience. Anticipation and suspense during gameplay can be accomplished by modifying the pace of the game and/or generating feedback to the player.

### SUMMARY OF THE INVENTION

An object of the present invention is to entirely stop the action of a game to alert the player to the possible win, allowing the player to finish out the game at the player's direction. A first advantage of allowing the game to continue upon the player's direction is that the player will recognize that he or she is very close to an important (potentially big winning) combination. Another advantage is that allows the player to alert nearby friends and family that there is potential of a large award, giving them time to come over to the gaming machine to watch the result as it happens. Another advantage allows the player to draw the final game symbol or symbols when desired, allowing everyone around to prepare for the result, or to engage in any good luck rituals which add to their enjoyment or are perceived to help their chances.

Another object of the present invention is to change the speed, or pace, at which the symbols of a gaming machine are displayed based on the possible outcomes. This could apply to any gaming machine where one or more symbols of a final outcome are unknown.

Another object of the present invention is to reveal to the player the symbols that are part of the preferable hand by altering the appearance of these symbols. This can be done in any manner which calls attention to the symbol, including but not limited to changing the symbol position on the display, adding color highlights, animating the symbol, changing its color or putting a box around it.

Another object of the present invention is to change highlighted symbols such as in the case when a more preferable hand is available, which can include different symbols than the ones that were highlighted before. Each time a new symbol is added to the game, the machine determines the best preferable hand to highlight and adjusts the highlights to show this symbol combination.

Another object of the present invention is to provide meaningful feedback to the player upon accomplishing preferred hands. This can take the form of exciting sounds, graphics, lights, material being ejected (e.g., confetti), or in one embodiment can be the audio and/or video excitement by play-by-play announcers for the game. This same type of feedback may also be used when the player is very close to a preferred hand.

It will of course be understood that the aspects and objectives of the invention are various, and need not be all present in any given embodiment of the invention. The features, advantages and accomplishments of the invention will be further appreciated and understood upon consideration of the following detailed description of an embodiment of the invention, taken in conjunction with the drawings, in which:

### BRIEF DESCRIPTION OF THE DRAWINGS

FIG. 1 is an illustrative screen of a mechanical reel slot machine in accordance with the present invention;

FIG. 2 is an illustrative screen of a mechanical reel slot machine in accordance with the present invention;

FIG. 3 is an illustrative screen of a video reel slot machine in accordance with the present invention;

FIG. 4 is an illustrative screen of a video reel slot machine in accordance with the present invention;

FIG. 5 is an illustrative screen of a video reel slot machine in accordance with the present invention;

FIG. 6 is a paytable in accordance with the present invention;

FIG. 7 is a paytable with multiplier in accordance with the present invention;

FIGS. 8-11 are illustrative screens from a “Multi-Strike” video display slot machine according to the present invention;

FIG. 12 is an illustrative screen from a “Multi-Strike” video display slot machine highlighting an anticipation combination according to the present invention; and

FIGS. 13-16 are illustrative screens from a “Multi-Strike” video display slot machine including an indicator according to the present invention.

### DETAILED DESCRIPTION OF EMBODIMENTS OF THE INVENTION

The present invention has its genesis in the video gaming machine environment. While it will be particularly discussed with respect to embodiments in that arena, it will be understood that this is but one application of the invention, and the invention has much broader scope. For example, the present invention can be played on hand held game players or on personal computers, including game consoles and even coin-operated amusement devices.

The present invention is applicable to any machine where the results involve multiple game element locations, or symbols. For illustration, embodiments discussed herein include mechanical reel slots, video slots, Keno and video poker. It should be understood that the present invention may be used for any symbol oriented game including, but not limited to, dice, cards, tiles or bingo.

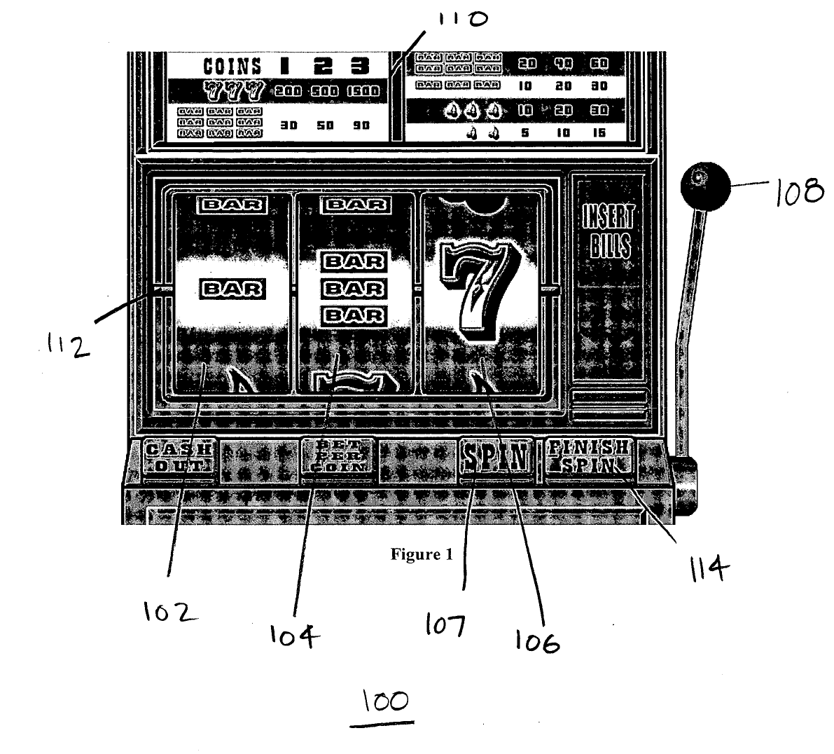

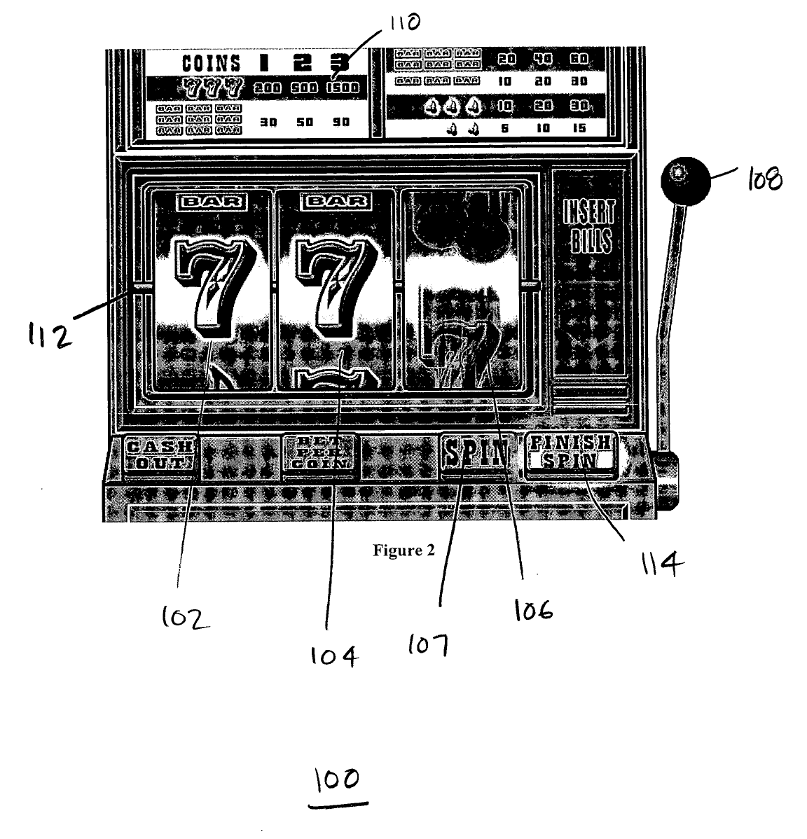

One embodiment of the present invention is a gaming machine in the form of a mechanical reel slot machine, as shown in FIGS. 1 and 2. The machine 100 has physical reels 102, 104, 106 which are set into motion when the player starts the game. As shown in FIG. 1 three reels are implemented, but any number of reels could be used without departing from the invention. The player inserts money to establish credits on the machine 100, as is well known in the art. A button 107 is pressed or a handle 108 is pulled to commence the game.

Without any player input, the reels 102, 104, 106 stop one at a time in sequence, typically from left to right, although any stopping order is contemplated. The result is shown on payline 112, although any number of paylines could be used. A paytable 110 shows various winning symbol combinations, for example the symbol combination “7-7-7” is considered a winning combination, or preferable hand. Although, any number of winning symbol combinations could be identified as a preferable hand.

FIG. 2 illustrates the machine 100 after reel 102 and reel 104 have stopped, each showing a “7” on the payline 112. The machine 100 detects this 7-7 partial combination as a “valid anticipation combination”—anticipating a possible winning combination—and suspends the game by continuing to spin the last reel 106 while making a sound and illuminating the “Finish Spin” button 114. The gaming machine 100 continues spinning reel 106 until the player presses the “Finish Spin” button 114, which ends the game suspension. The light in the “Finish Spin” button 114 turns off and the game is completed by bringing reel 106 to a stop. All payouts determined from the final outcome, or final combination of symbols, are awarded according to the paytable 110. In an alternate embodiment, the game could detect a “7” on the first reel 102 as a valid anticipation combination such that the “Finish Spin” button 114 is illuminated while reel 104 and reel 106 remain in motion. The player would then press the button 114, either once or twice (for each reel), to stop reels 104 and 106.

Alternatively, in a wagering game, once a valid anticipation combination has been detected by the gaming machine and play has been suspended, the player can make one or more additional wagers on the final outcome. There are many different types of wagers that could be made at this point in the game. For example, the player could place an additional wager that one of the preferable hands, or winning combinations, will be the final outcome. The payout for the additional wager could be neutral (same payout odds as the odds directed to the winning combination), positive (higher payout odds compared to the odds directed to the winning combination) or negative (lower payout odds compared to the odds directed to the winning combination), as is well known in the art.

Additionally, the player could place an additional wager against the possibility of a preferable hand as the final outcome. Another possibility is that the player could place an additional wager that causes the payouts of the game in progress to be multiplied, for example, by a fixed multiplier. In another embodiment, the multiplier could be randomly determined after the game is resumed from the suspended state. The exact nature of an additional wager after the game is suspended can take many, many forms and these examples are only a few ways to illustrate the concept.

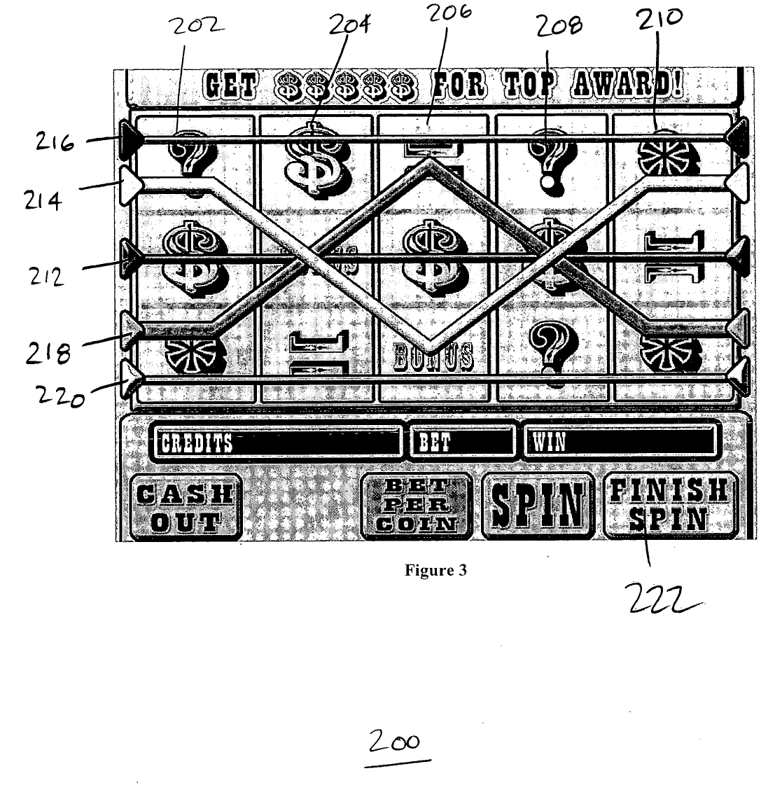

Another embodiment of the present invention is a gaming machine in the form of a video reel slot machine, as shown in FIGS. 3 through 5. Gaming machine 200 has five reels 202, 204, 206, 208, 210 and multiple paylines 212, 214, 216, 218, 220. This gaming machine 200 is typically known and referred to as Australian Video Slots. Three symbols from each of the five reels 202, 204, 206, 208, 210 are shown on the screen. Each payline 212, 214, 2116, 218, 220 typically includes one symbol position from each of the five reels 202, 204, 206, 208, 210. For the purpose of this invention it is not important how many reels, how many symbols per reel are shown, how many paylines or the configuration of the paylines. The reels, symbols per reel shown and type and configuration of paylines may be modified without departing from the invention.

As an example, in reference to FIG. 3, one preferable hand, or winning combination, is four dollar sign ($) symbols scattered anywhere on the reels 202, 204, 206, 208, 210, although a preferable hand can include any number of symbols, for example, five dollar sign symbols scattered anywhere on the reels 202, 204, 206, 208, 210.

In this example, the valid anticipation combination is three dollar sign symbols scattered anywhere on the reels 202, 204, 206, 208, 210. An anticipation combination is typically less than all symbols defining a winning combination, otherwise referred to here as a preferable hand. If any stopped reels show three dollar sign symbols with one or more reels still in motion, then as a result of detecting this valid anticipation combination the gaming machine 200 suspends the game such that no more reels are stopped and the remaining reels continue to spin, or remain in motion. The gaming machine 200 will then provide a way for the player to finish the game.

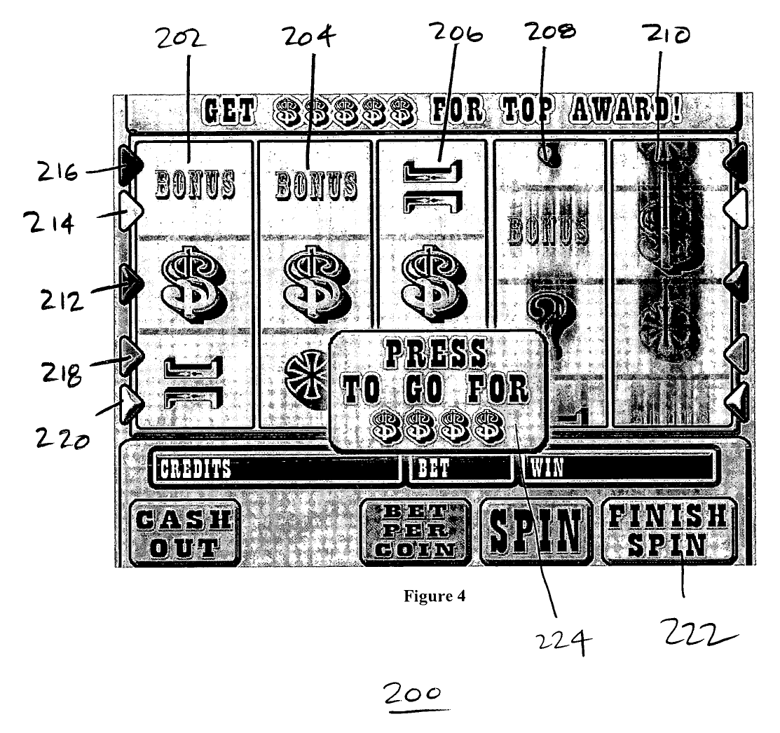

The player can finish the game by selecting the “Finish Spin” button 222. Another method could use a touch screen device, as is well known in the art, providing an on-screen button which instructs the player to touch the button to finish the game. FIG. 4 shows the gaming machine 200 with the three dollar sign symbols on the first three reels 202, 204, 206 with the fourth reel 208 and fifth reel 210 in motion and the “Press to go for four dollar signs” button 224 on-screen. The remaining reels 208, 210 continue to spin until the player presses the onscreen button 224. Although a mechanical button and an on-screen button have been described above, any signaling method may be used without departing from the invention.

In another embodiment, once a valid anticipation combination is detected by the gaming machine, then the rate, or pace, changes for subsequent symbols shown. For example, in the video slot machine 200 of FIGS. 3-5, the reels 202, 204, 206, 208, 210 are stopped left to right every quarter second. Once a valid anticipation combination is detected, the reels are stopped according to a delay.

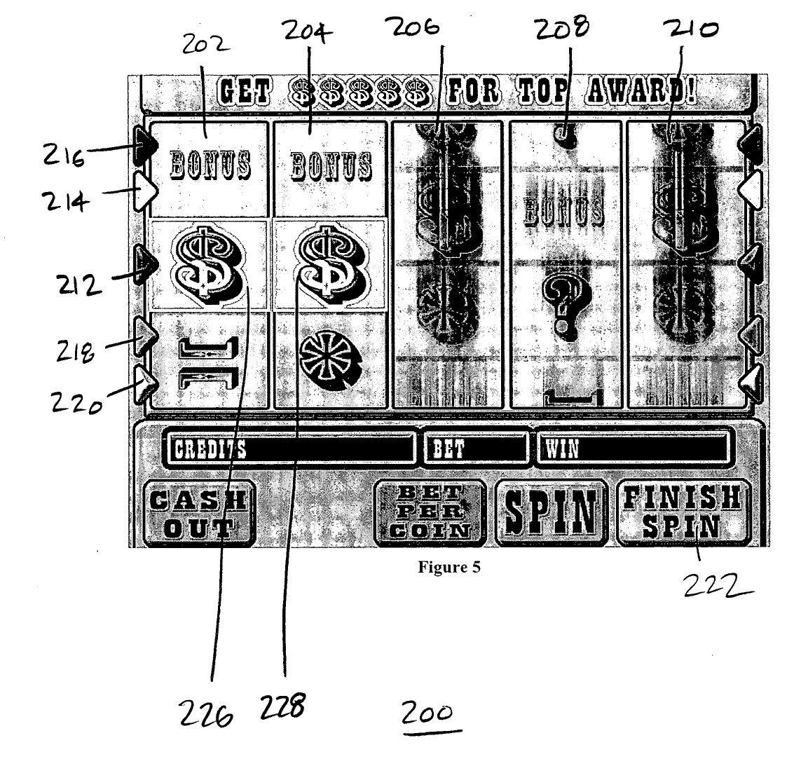

Turning to FIG. 5, the anticipation combination is two dollar sign symbols scattered on the reels 202, 204, 206, 208, 210. In this embodiment, once the anticipation combination is detected on reels 202, 204, the delay for stopping subsequent reels 206, 203, 210 changes to three seconds for each remaining reel. It can be appreciated that different delays between reel stops can be used before or after an anticipation combination is detected. As shown in FIG. 5, once the second dollar sign symbol is shown on the stopped reels 202, 204, the gaming machine 200 highlights the two dollar sign symbols 226, 228 by brightening, or lighting up the symbols and placing rectangular boxes around the symbols. Further, the gaming machine 200 makes a sound at the same time. In this embodiment, the delay before each subsequent reel 206, 208, 210 stops increases to three seconds. The highlighting, sound and delay allow the player to understand that a high paying combination may be possible and to focus with anticipation as the remaining reels 206, 208, 210 are stopped to display the results at a speed that allows easier comprehension of the action.

It is also contemplated that once the game is suspended due to the determination of a valid anticipation condition, the game can be finished out in a plethora of different methods. For example, after a anticipation condition is determined, instead of pressing a button as described in reference to FIGS. 1-5, a bonus game could be initiated to determine the final outcome on the suspended reel(s) in the base game. The conclusion of the bonus game results in the selection of the symbol or symbols to finish out the base game. The bonus game could be a derivative of the base game, or a game that is separate and distinct from the base game. For example, the bonus game could be a matrix of hidden symbols behind a touch screen icon. The player selects an icon to reveal the hidden symbol and thus, the final outcome, or preferable hand, of the base game.

A Keno-type game, as it is well known in the art, is enhanced by the present invention. The anticipation condition could stop play once a certain number of matching numbers have been drawn. For example, in a ten spot Keno-type game, the anticipation condition, or threshold, could be seven matching numbers. If seven numbers out of ten selected by the payer are matched, and all twenty random numbers have not been drawn, then the game would stop the selection of new numbers and the player would press a button to finish out the game. The player could press the button once for the machine to select the remainder of the numbers. Otherwise, the player could press the button to continue play for the draw of each remaining number in the game. In another embodiment, the remaining numbers would be selected and the game would stop again for a second anticipation combination, for example, eight matching numbers.

In another embodiment of a Keno-type game incorporating an aspect of the present invention, once the anticipation threshold is met (for example, if the player has five matching numbers on a nine number game) then the game slows the rate at which subsequent numbers are selected. For example, the game may initially select the drawn numbers at a rate of one-third second per number. Once the player has five matching numbers then all remaining numbers would be drawn with a delay of two seconds per number. Of course, these exact time intervals could be modified without departing from the invention.

The present invention includes more than one anticipation threshold. For example, consider a twelve spot Keno-type game that has a first anticipation threshold of eight and a second anticipation threshold of ten. The player selects twelve numbers and twenty random numbers are drawn that the player desires to match. The twenty numbers are drawn at a rate of three numbers per second until all twenty numbers have been drawn or until the player has eight matching numbers. If the player has eight matching numbers, the first anticipation threshold is met and the game slows the draw time to two seconds per number. Numbers are continuously drawn until all twenty numbers have been selected or until the player has ten matching numbers, meeting the second anticipation threshold. The second anticipation threshold stops the game and displays a message on the touch screen to prompt the player to press a button to draw the remaining numbers. The game may also display the size of the potential prizes for matching each or both of the last two numbers. Play is resumed and the remaining numbers are drawn when the player touches the button on the touch screen.

The present invention can incorporate card games, for example, Draw Poker, Stud Poker, Texas Hold 'em and Omaha, to name a few. Draw Poker traditionally deals five cards to the player, although any number of cards can be dealt. The player selects to hold or discard any of the initial five cards dealt and then replacement cards are given for each discarded card. On either the deal or the draw, the player could be only a few cards away from a large winning combination without even noticing or could end up with a bigger win without enjoying the anticipation along the way. Once a valid anticipation combination occurs, on the deal or the draw, the remaining cards can be dealt at a slower pace or stopped, enhancing player anticipation of the possible award. If play is suspended, the player could select a button to deal out the remaining cards.

With Stud Poker, the player must play the cards dealt without the option to get replacement cards. When more than five cards are dealt in Stud Poker, then it is customary that the player uses the best five cards out of the entire set of cards the player receives. If a valid anticipation combination occurs on the deal, the remaining cards can be dealt at a slower pace or stopped, wherein the player could select a button to deal out the remaining cards.

The present invention includes card games that use more than five cards. With respect to a Texas Hold 'em-type game, the player receives a two-card starting hand, and then five “community cards” are dealt. The community cards are available to all players playing the game (gaming machines can be networked). The player then makes the best five-card poker hand out of the seven cards available. If a valid anticipation combination occurs on the deal, the remaining cards can be dealt at a slower pace or stopped, wherein the player could select a button to deal out the remaining cards.

In an alternate embodiment, the player can be given a choice between more than one two-card starting hands. The player selects one two-card starting hand, and the non-selected starting hands are returned to the deck. Five community cards are dealt from the resulting deck. If a valid anticipation threshold is met, for example the selection of a certain two-card starting hand, the remaining cards can be dealt at a slower pace or stopped, wherein the player could select a button to deal out the remaining cards.

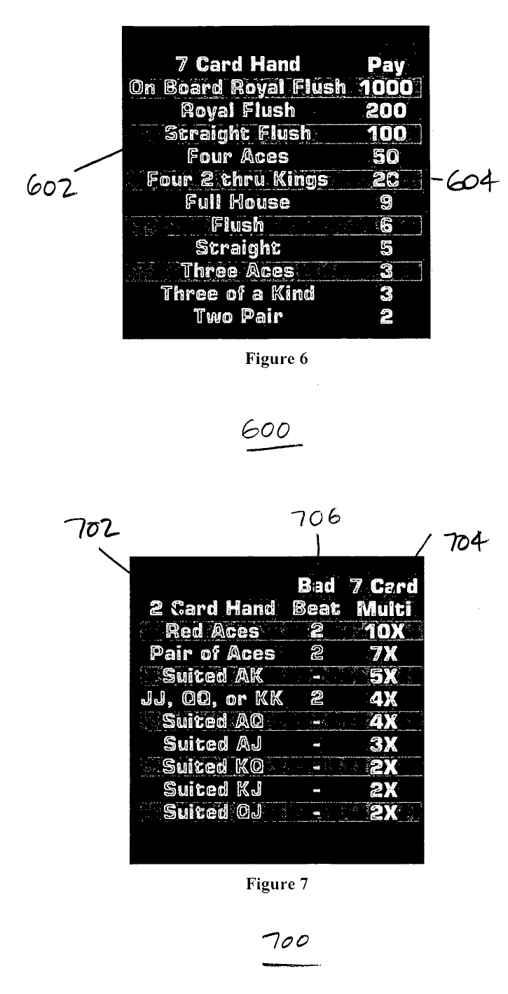

FIG. 6 illustrates a possible paytable 600, including the winning final outcomes 602 and the payout 604 of each. The payout for specific hands is based upon a certain number of credits wagered, for example every two credits wagered. Payouts can be scaled by a multiplier. FIG. 7 is a paytable 700 of starting hand multipliers. Certain combinations 702 of an initial two-card starting hand have multipliers 704 as well as Bad Beat multipliers 706 if the selected initial two-card starting hand fails to become a winning final outcome.

With respect to embodiments described herein where the player is given a choice between two or more starting two-card hands, the paytable can include a multiplier for a certain premium two-card starting hand (“7 Card Multi”). That is, if the two-card starting hand that is selected by the player is one of the combinations 702 of the paytable 700 of FIG. 7, then the corresponding multiplier 704 is applied to any winning final outcome 602 of the paytable 600 of FIG. 6. These and other game payout determinations are further described in U.S. Published Patent Application No. 20060128454, incorporated by reference herein.

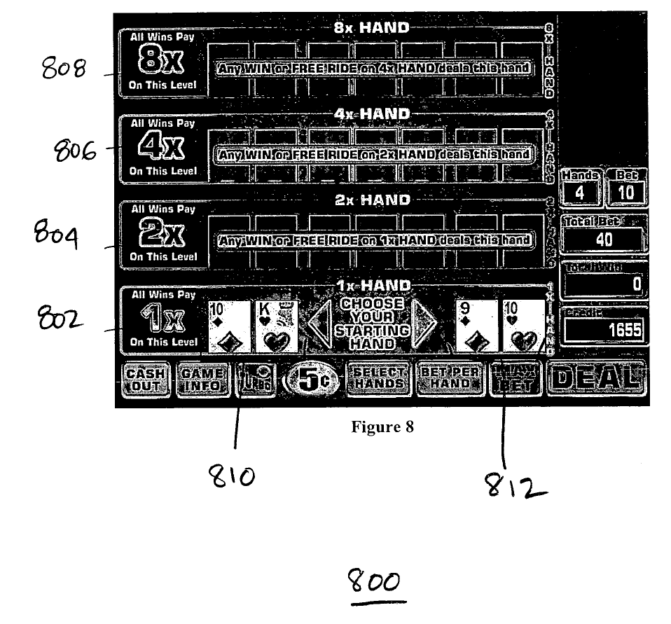

FIGS. 8-16 illustrate an embodiment of the present invention as applied to Multi-Strike Poker, as described in U.S. Pat. No. 6,612,927, incorporated herein by reference. The game display 800 includes four levels 802, 804, 806 and 808, each with a respective multiplier of 1×, 2×, 4× and 8×. With the embodiments described herein in reference to FIGS. 8-16, any winning final outcome can be multiplied by as little as 1× and as much as 80× (starting hand multipliers (FIG. 7) of 1×, 2×, 3×, 4×, 5×, 7× or 10× times stage, or level, multipliers of 1×, 2×, 4× or 8×).

The anticipation combinations which cause the game to modify the pacing and/or generate additional feedback are comprised of any hand that has two pair or better, in addition to any hand that could become a straight, flush or straight-flush. Of course, any combinations of symbols could be used for this purpose without departing from the invention.

As shown in FIG. 8, the player begins on the 1× level 802 and is dealt two two-card hands 810, 812 to choose from. In this example the hand 812 is selected. Hand 810 is returned to the deck, which is used to draw five community cards. The two-card hand selected does not correspond to a hand multiplier of paytable 700 of FIG. 7.

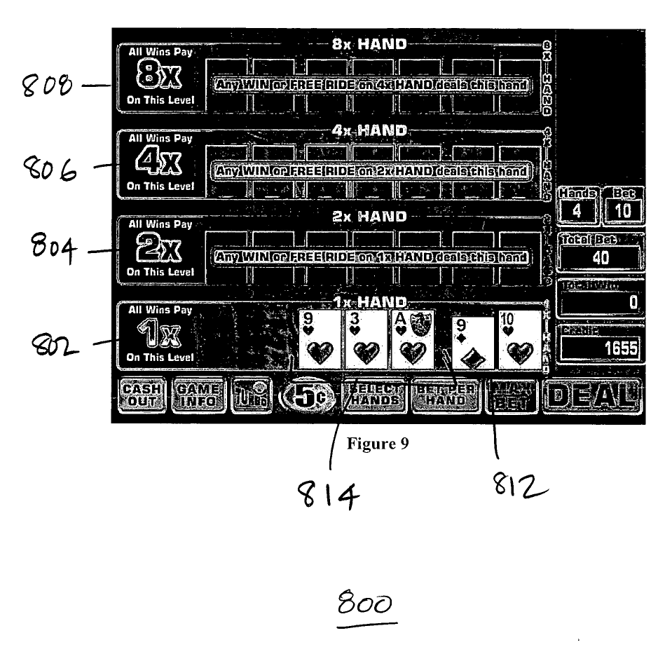

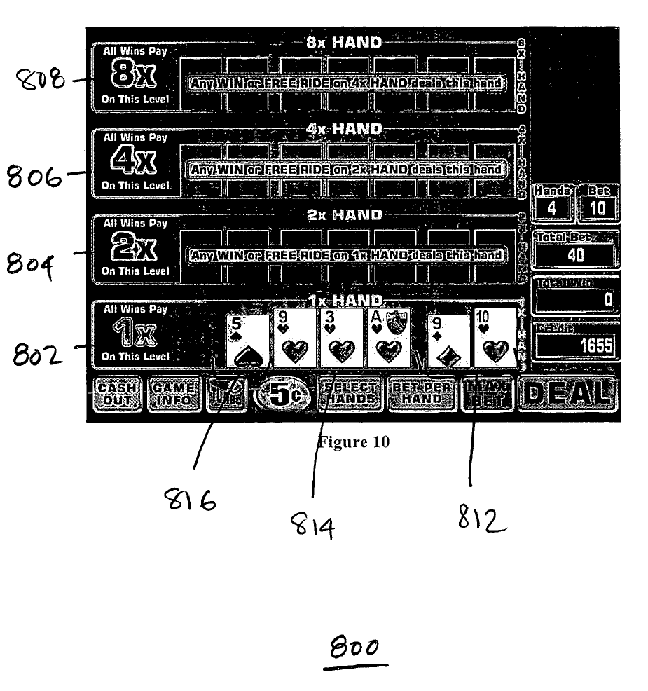

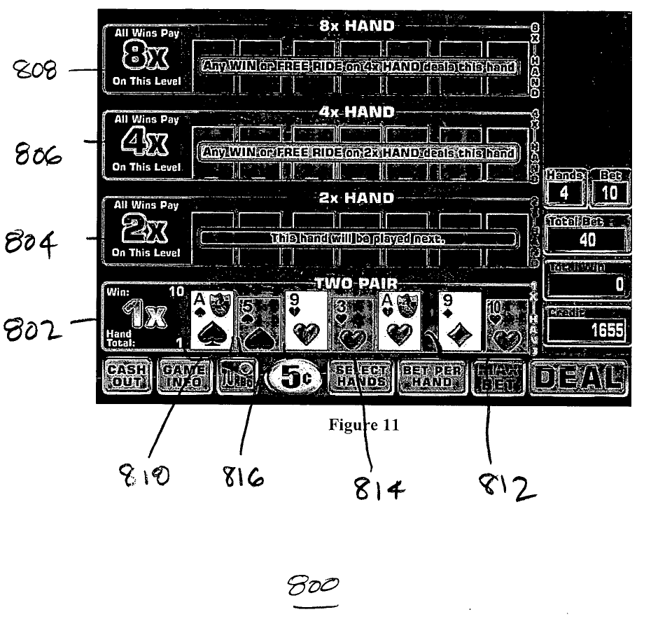

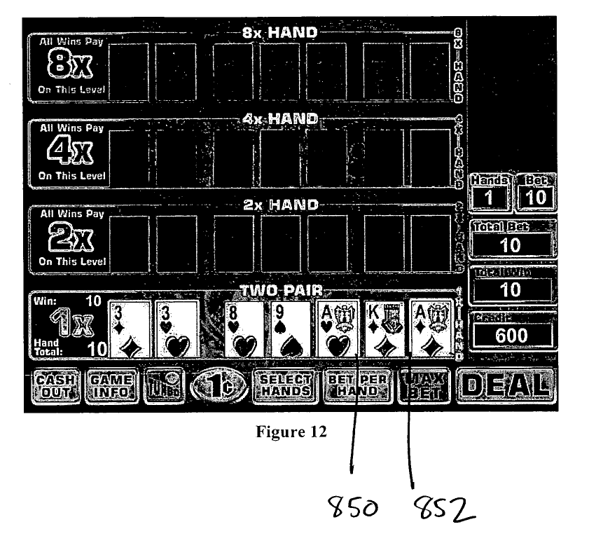

The first three community cards (“flop”) are dealt shown at 814 in FIG. 9. The gaming machine evaluates the cards, including the player's two-card hand and the flop, to determine if an anticipation combination is present. If no anticipation combination is found, then the fourth community card (“turn”) is quickly dealt 816 (FIG. 10). If there are no anticipation combinations in this six-card hand then the final community card (“river”) is dealt 818 (FIG. 11) and a final evaluation of the hand is made according to the final outcomes 602 of paytable 600 (FIG. 6). In the absence of anticipation combinations in the first six cards, the flop, turn and river would deal in rapid succession with no graphical changes, or modifications to the display. Note that while these are called “community cards” based on the function in live Texas Hold 'em games, the third through seventh cards are merely cards in the player's hand, as there is no opponent in this variation of the Texas Hold 'em game.

As shown in FIG. 9, the flop results in an anticipation combination of four cards to a flush. Upon detecting this combination, the gaming machine alerts the player in a mild manner so as to not have the impact of a win. At the same time, the cards that comprise the anticipation combination are highlighted by being graphically moved toward the player, or raised, to call attention to the combination that could lead to a win. In this case, the four cards to the flush (9 h, 3 h, A h, 10h) pop up in an animated fashion and remain as shown in FIG. 9. Instead of quickly displaying the turn and river cards, for example at a quarter second per card, the game slows down the delay between cards to two seconds per card. This gives the player the ability to look at the raised cards to understand the hand, for example that a heart card on the turn or the river will result in a flush for the player. In another embodiment, play could stop for this type of draw or otherwise be reserved for hands with loftier possibilities.

FIG. 10 shows that the “five” of spades dealt on the turn 816 (fourth community card) is no help toward a winning final outcome. FIG. 11 shows the Ace of Spades dealt on the river 818 (the fifth community card). Once the hand is over, the cards that comprise the anticipation combination are graphically moved back downward, and any winning final outcome is raised to allow the player to quickly and easily recognize the cards that make up the winning hand. As shown in FIG. 11, the player did not get the flush that was close to a winning hand, (shown in FIGS. 9 and 10) but the player did get two pair (Aces and Nines). Highlighting the winning final outcome at the end of the hand allows the player to easily understand the winning hand.

The feature of highlighting the cards in the anticipation combination and in any winning hand applies to any game, but is particularly helpful in this seven card game where only five cards are ever in play at a time. While the highlighting is shown by graphically raising the cards vertically, this highlighting may be achieved in other ways without departing from the invention, such as the highlight boxes 850, 852 as shown in FIG. 12, which can be of any color.

As the seven cards are dealt to the player, the deal maintains a rapid first speed until the first anticipation combination is detected. At this time, the highest paying combination is highlighted. If there is no paying combination, then the anticipation combination that could potentially result in the highest hand is highlighted. Thus, several changes in highlighting can occur as the hand is dealt out. The speed at which cards are dealt slows down to a slow second speed with the detection of the first anticipation combination and remains slow as long as the result of the hand can be improved toward a winning final outcome. In one embodiment, if the hand cannot be further improved then the dealing speed reverts to the rapid first speed used before the first anticipation combination was detected.

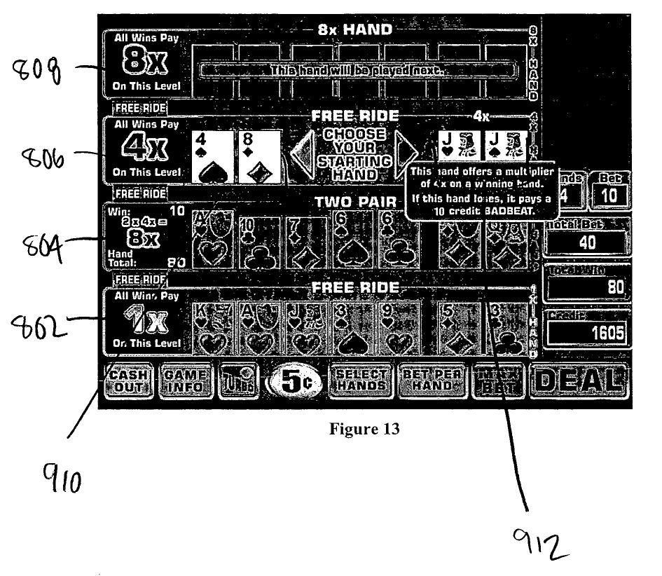

In FIG. 13, the player is dealt two two-card hands 910, 912 on the 4× level 806 (after a Free Ride on 1× level 802 and two pair on 2× level 804). This two-card starting hand provides a 4× multiplier, as shown in paytable 700 of FIG. 7. If the hand loses, the credit bet on that hand (here, 10 credits) is returned as a “Bad Beat” bonus (and counted as a Multi-Strike win). Any result is multiplied by the 4× level 806 multiplier of four, thus a losing hand will award forty credits (level multiplier of 4 times the 10 credit bet on the hand) and a winning hand will be multiplied by 16× (level multiplier of 4 times the starting hand multiplier of 4 for the two jacks).

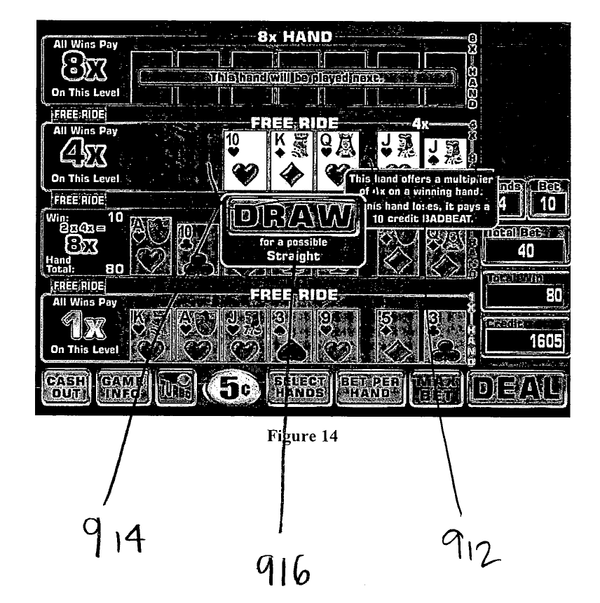

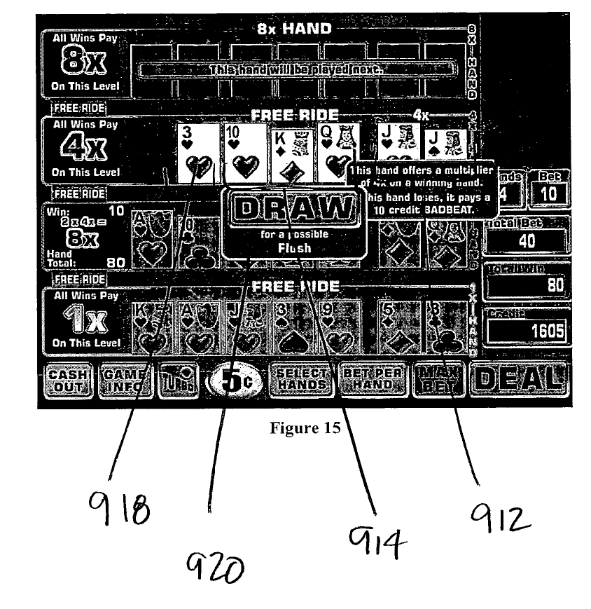

FIG. 14 shows the flop 914 after the two jack starting hand 912 is selected. In this embodiment, the game stops on the hands that have the potential for very large wins. Not only are the cards dealt to a player's hand used as anticipation combinations to slow down the pacing of the game, multipliers—for example 1× to 80×—of this embodiment may also be a factor to determine when to stop, or slow down the game. Thus, pacing is not based only on symbol combinations.

To determine whether or not to stop the game, the gaming machine computes the best possible hand that could result including the next card drawn, and if the payout value including all multipliers (for the starting two-card hand multiplier and multi-strike level multiplier) meets a specific threshold, for example forty times the bet per hand, then the game stops and displays an indicator 916 as shown in FIG. 14. For example, the possible straight from the flop 914 and the starting hand 912 is worth twenty-five credits times the 16× multiplier, or 400, which is also forty times the ten credit bet per hand. The game therefore stops the action and displays an indicator 916 telling the player to press the onscreen button to draw and it also indicates that a straight can be achieved from the draw. It is contemplated that there are recordings of play by play announcers that encourage the player as the draw is anticipated. The game stops, playing music to add a little tension, while waiting for the player to press the draw button 916.

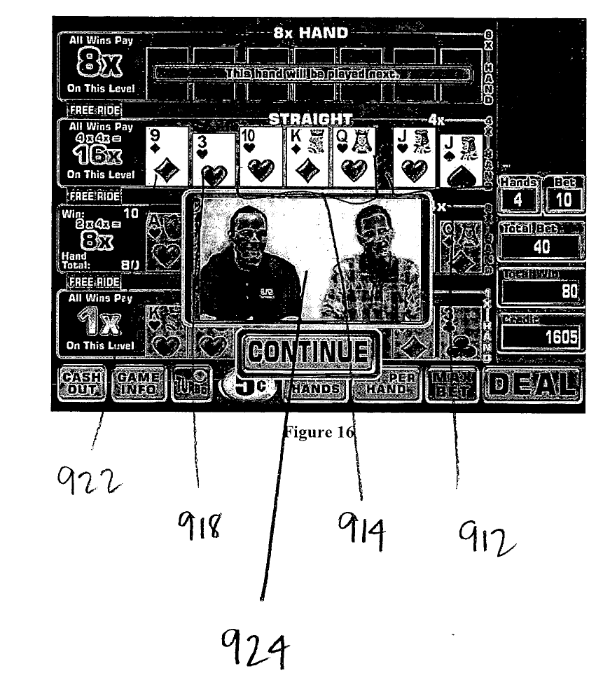

After the draw button 916 is pressed, the “turn” card is dealt 918 as shown in FIG. 15. Here, the turn is the three of hearts. There is still no winning combination in this hand, however, now the best possible hand available with one more card is a flush. So the king of diamonds, which was highlighted by being raised as shown in FIG. 14, becomes un-highlighted and moves back down as shown in FIG. 15. The three of hearts is raised such that all four cards presenting a possible flush become highlighted. Because the possible win is also over the 40× credit threshold, the game stops again and displays an indicator 920 (“Draw for a possible Flush”) to the player. The gaming machine stops and waits for the player to press the button 920.

As shown in FIG. 16, the hand ends when the player receives the nine of diamonds on the river 922. This card creates a straight, so the three of hearts becomes un-highlighted while the king and nine of diamonds pop up to highlight the winning hand. In this embodiment, an audio/video segment 924 is played showing the announcers very excited about the player's big draw.

The speed of the deal could slow down as successive hands are highlighted as shown in FIGS. 13-16 (highlighting the straight draw, then the flush draw, then the “made straight” respectively). Decreasing the speed is helpful to the player once there are possible winning hands to consider. Changing highlights and reinforcing the possible winning hands simultaneously via sound cues allows the player to quickly play through the “uninteresting” hands and focus on the changing opportunities in the “lucrative” hands.

While the present invention has been described with reference to particular embodiments, those skilled in the art will recognize that many changes may be made thereto without departing from the scope of the present invention. Each of these embodiments and variants thereof is contemplated as falling with the scope of the claimed invention, as set forth in the following claims.

What is claimed is:

1. A method for operating a gaming machine, comprising the steps of:
entering a wager on the gaming machine;
providing game element locations to reveal symbols including a methodology for revealing a plurality of said symbols in the course of gameplay, wherein said methodology includes suspending the revelation of a game element location symbol when an anticipation combination is detected;
then activating the suspended game element location;
presenting a final outcome; and
determining an award based on the final outcome of the gameplay.

2. A method for operating the gaming machine of claim 1, wherein playing the game element locations includes a delay sequence for said at least one game element location that is suspended before revealing a symbol for said suspended location(s).

3. A method for operating the gaming machine of claim 1, wherein activating the suspended game element location results in a bonus game.

4. A method for operating the gaming machine of claim 1, wherein activating the suspended game element location includes the ability to place a second wager.

5. A video poker gaming machine which utilizes a plurality of game elements that are combinable in the course of a predetermined temporal sequence of play, wherein the improvement comprises:
triggering a player perceptible slowing in the temporal sequence of play, when an anticipation combination results in the course of said sequence of play, then resuming play after said slowing.

6. A method of operating a gaming machine, comprising the steps of:
placing a wager;
providing a first game of chance on the gaming machine which has a plurality of game elements;
suspending said first game of chance when less than all of said game elements meet a predetermined condition;
registering user input to resume said first game of chance;
selecting said game elements that were suspended to a final outcome;
evaluating said final outcome for a winning condition; and
awarding any payout achieved in said first game of chance.

7. The method of claim 6 further comprising the step of supplying a signal for said user input.

8. The method of claim 6 wherein said predetermined condition is a specific game element combination.

9. The method of claim 6 wherein said predetermined condition is a threshold value and said payout for game elements that could be a potential winning combination is greater than said threshold value.

10. The method of claim 6 wherein said first game of chance is a card game and wherein said step of providing said first game of chance includes dealing a hand of cards to a player.

11. The method of claim 10 wherein said card game is a five card poker game.

12. The method of claim 10 wherein said card game further comprises the step of dealing an opening hand of cards from which a player can choose to select cards to hold as well as select cards to discard.

13. The method of claim 10 wherein said card game further comprises the step of dealing an opening hand of cards from which a player can choose to select cards to hold as well as select cards to discard, said card game including the further step of replacing any discarded card with another randomly selected card.

14. The method of claim 10 wherein said first game of chance is a slot game having a reel display with a plurality of reels having first game indicia thereon, and wherein said step of providing said first game of chance includes a display of randomly selected first game indicia for each reel.

15. The method of claim 10 wherein said card game further comprises the step of dealing a first set of cards and a second set of cards, wherein a player can choose to select one of said two sets of cards for an opening hand.

16. The method of claim 15 including a paytable for said selected set of cards, wherein said set of cards corresponds to a multiplier to be applied in the step of awarding said payout.

17. The method of claim 6 wherein a paytable of different multipliers is provided with an award being earned through achievement of a winning condition.

18. The method of claim 6 wherein the step suspending said first game of chance includes a second wager on the final outcome.

19. The method of claim 18 wherein said second wager has greater odds than said initial wager.

20. The method of claim 18 wherein said second wager has odds less than said initial wager.

21. The method of claim 18 wherein said second wager has the same odds as said initial wager.

22. The method of claim 18 wherein said second wager is for a payout awarded for no winning condition of said final outcome.

23. The method of claim 6 wherein said user input is a mechanical button.

24. The method of claim 6 wherein said user input is a touch screen button.

25. A method of operating a gaming machine, comprising the steps of:
placing a wager;
providing a game of chance on a display which has a plurality of game symbols in a sequence of play;
changing said display to call attention to said game symbols when at least one game symbol meets an anticipation condition;
evaluating said game symbols for a winning outcome;
awarding any payout achieved in said game of chance.

26. The method of claim 25 further comprising slowing said sequence of play upon said anticipation condition.

27. The method of claim 26 wherein said slowing is suspending said sequence of play.

28. The method of claim 27 further comprising the step of registering user input to resume said game of chance after said suspension.

29. The method of claim 27 wherein said suspension of said game of chance activates a second game of chance wherein said outcome of said second game of chance determines said game elements for said remaining symbols.

30. The method of claim 28 further comprising the step of supplying a signal for said user input.

31. The method of claim 25 wherein said anticipation condition is a predetermined game element.

32. The method of claim 25 wherein said anticipation condition is more than one predetermined game element.

33. The method of claim 25 wherein said anticipation condition is a threshold value and said payout for said game symbols that could be a potential winning outcome is greater than said threshold value.

34. The method of claim 25 wherein said game of chance is a slot game having a reel display with a plurality of reels having first game indicia thereon, and wherein said step of providing said game of chance includes a display of randomly selected first game indicia for each reel.

35. The method of claim 25 wherein said game of chance is a card game and wherein said step of providing said game of chance includes dealing a hand of cards to a player.

36. The method of claim 35 wherein said card game is a five card poker game.

37. The method of claim 25 further comprising a paytable, wherein said game symbols correspond to a multiplier to be applied in the step of awarding said payout.

38. The method of claim 27 wherein the step suspending said game of chance includes a second wager on the winning outcome.

39. The method of claim 38 wherein said second wager has greater odds than said initial wager.

40. The method of claim 38 wherein said second wager has odds less than said initial wager.

41. The method of claim 38 wherein said second wager has the same odds as said initial wager.

42. The method of claim 38 wherein said second wager is for a payout awarded for no winning outcome.

43. A method of operating a gaming machine, comprising the steps of:
placing a wager;
providing a first game of chance, wherein said first game of chance is a slot game having a reel display with a plurality of reels having first game indicia thereon;
operating said first game of chance by displaying at least one randomly selected first game indicia for each reel of said plurality of reels in said reel display;
suspending said first game of chance when said game indicia for at least one reel of said plurality of reels in said reel display meets an anticipation condition;
resuming said first game of chance to a final outcome upon input from the user; and
awarding any prize award achieved in said first game of chance.

44. The method for operating the gaming machine of claim 1, wherein the display of said symbols changes upon said detection of said anticipation condition.

45. The video poker gaming machine of claim 5, wherein said slowing is stopping said sequence of play.

46. The video poker gaming machine of claim 45 further comprising a user input to resume said sequence of play.

47. The video poker gaming machine of claim 5 further comprising highlighting said anticipation combination that results in said course of play.

48. The method of operating the gaming machine of claim 6 further comprising highlighting said game elements that meet said predetermined condition.

49. The method of operating the gaming machine of claim 25, wherein the display of said game elements change upon said detection of said anticipation condition.

50. The method of claim 6 further comprising a second game of chance initiated upon said suspension of said first game of chance.

51. A method of operating a gaming machine, comprising the steps of:
placing a wager;
providing a first game of chance on the gaming machine which has at least first position for a first game element, a second position for a second game element, and a third position for a third game element;
suspending said first game of chance when said first game element meets an anticipation condition;
registering user input to resume said first game of chance;
selecting said second game element for said second position and said third game element for said third position;
evaluating said game elements for a winning outcome;
awarding any prize achieved in said first game of chance.

52. The method of claim 28 wherein said user input is a mechanical button.

53. The method of claim 28 wherein said user input is a touch screen button.

54. The method of claim 52 wherein said mechanical button includes a light that illuminates upon suspension of said first game of chance.

55. The method of claim 6 further comprising the step of displaying a video feedback.

56. The method of claim 6 further comprising the step of providing an audio feedback.

57. The video poker gaming machine of claim 5 further comprising a video feedback.

58. The video poker gaming machine of claim 5 further comprising an audio feedback.
